(19) United States
(12) Patent Application Publication
(10) Pub. No.: US 2008/0011978 A1
(43) Pub. Date: Jan. 17, 2008

(54) Heat transport medium with fine-particle dispersion

(75) Inventors: Touru Kawaguchi, Kariya-city (JP); Eiichi Torigoe, Anjo-city (JP); Yoshimasa Hijikata, Nishikamo-gun (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-ctiy (JP)

(21) Appl. No.: 11/728,634

(22) Filed: Mar. 27, 2007

(30) Foreign Application Priority Data
Mar. 29, 2006 (JP) 2006-91277

(51) Int. Cl. C09K 5/04; C09K 5/00

(52) U.S. Cl. 252/69

(57) ABSTRACT

A heat transport medium for transporting heat transferred from a heat transfer surface includes a liquid medium, and fine particles of a predetermined material dispersed into the liquid medium. The fine particles are contained in the liquid medium in volume content to provide an improvement rate of a heat transfer coefficient of about 1.0 or more. Here, the heat transfer coefficient is an index representing ease of heat transfer of the medium between the heat transfer surface and the medium by addition of the fine particles.

### CROSS REFERENCE TO RELATED APPLICATION

This application is based on Japanese Patent Application No. 2006-91277 filed on Mar. 29, 2006, the contents of which are incorporated herein by reference in its entirety.

### FIELD OF THE INVENTION

The present invention relates to a heat transport medium with fine-particle dispersion, which promotes heat transport by dispersing fine particles of a predetermined material into a liquid medium.

### BACKGROUND OF THE INVENTION

Conventionally, heat exchangers used in, for example, vehicle-mounted radiators or electronic devices, have employed a heat transport medium for transmitting and transporting heat from a heat source to the outside. Such a heat transport medium is required to have higher cooling capability, that is, higher heat transport capability so as to enhance energy efficiency. In order to improve the heat transport capability of the heat transport medium, a technique has been known which involves containing and dispersing solid particles made of a material having high thermal conductivity, such as metal, into the medium. The dispersion of the particles made of the material having the high thermal conductivity into the medium enhances the thermal conductivity of the medium as compared with that of a medium not containing the particles. More specifically, the thermal conductivity of the heat transport medium containing these particles has been known to be changed based on the following relation from a Maxwell equation published in 1881: the thermal conductivity of a medium containing spherical particles increases according to the volume fraction of the particles; and the thermal conductivity of the medium containing the spherical particles increases according to the ratio of the surface area of the particles to the particle volume thereof. Such a method for improving the thermal conductivity of the medium, however, is limited.

On the other hand, a technique for producing micron-sized or nanosized fine particles as particles contained in the medium has been recently developed. It has found that dispersing theses fine particles into the medium can enhance drastically the thermal conductivity of the medium. For example, a non-patent document 1 has reported that a small amount of fine particles made of copper (Cu) and having a diameter of 10 nm or less is dispersed in a medium made of ethylene glycol, thereby greatly improving the thermal conductivity of the medium.

FIG. 4 is a graph showing the relationship between the volume content (%) of particles in a medium and the improvement rate of the thermal conductivity (i.e., the ratio of a thermal conductivity k of the medium after addition of fine particles to a thermal conductivity k₀ of the medium before the addition of the particles) when various particles including the copper are added to the ethylene glycol. As shown in FIG. 4, when dispersing the particles having a diameter of about 30 nm and made of copper oxide (CuO), the particles having a diameter of about 30 nm and made of alumina (Al₂O₃), and the particles having a diameter of about 10 nm or less and made of copper into the media, in any case, the improvement rate of the thermal conductivity of the medium increases linearly with the increase in the volume content of the above-mentioned particles. In particular, in a case using the nanosized particles having the small particle size, for example, a diameter of 10 nm or less, only the addition of a small amount of the particles to the medium exhibits an effect of drastically improving the thermal conductivity of the medium. In the case of adding acid to copper particles, the particles tend to be dispersed stably into the medium, thereby providing the higher thermal conductivity to the medium. In FIG. 4, Cu (old) represents copper particles adjusted two months before the measurement, Cu (flesh) represents copper particles adjusted two days before the measurement, and (Cu+Acid) represents copper particles stabilized as metal particles by addition of acid.

Similarly to the non-patent document 1, non-patent documents 2 to 4 and patent documents 1 to 4 also have described that the thermal conductivity of the medium is improved by dispersing fine particles having high thermal conductivity into the medium.

Furthermore, in documents described above, methods for dispersing such fine particles into a medium are also described. More specifically, the methods include a method for dispersing fine particles into a medium as they are, a method for dispersing fine particles into a medium more stably by attaching a detergent to the surfaces of the particles, and a method for stably dispersing fine particles into a medium by adding a dispersant to the particles and the medium.

[Patent Document 1] JP-A-2004-501269 (corresponding to US 2005/0012069A1)

[Patent Document 2] JP-A-2004-517971 (corresponding to U.S. Pat. No. 6,447,692)

[Patent Document 3] JP-A-2004-538349 (corresponding to U.S. Pat. No. 6,695,974)

[Patent Document 4] JP-A-2004-85108

[Non-Patent Document 1]

Applied Physics Letters, Vol. 78, No. 6, pp. 718-720 (2001)

[Non-Patent Document 2]

Journal of Thermal Science, Vol. 11, No. 3, pp. 214-219

[Non-Patent Document 3]

Physical Review Letters, 94, 025901-1-4 (2005)

[Non-Patent Document 4]

Physical Review Letters, Vol. 93, No. 14, 144301-1-4

In the heat transport media described in the above documents, as shown in an example of FIG. 4, the improvement rate of the thermal conductivity of the medium is changed linearly with respect to the volume content of fine particles, and the thermal conductivity of the heat transport medium is improved with the increase in the amount of the fine particles. In other words, it is considered that the more the amount of the fine particles added to the medium, the more the heat transport capability of the heat transport medium is improved. Taking into consideration the utility or manufacturing costs of the above-mentioned heat transport medium, it is originally preferable that the addition or mixing of a possibly small amount of fine particles into the medium improves the heat transport capability. However, in the prior art, the relationship between the volume content of the fine particles in the medium and the heat transport capability of the medium is not revealed, and the adequacy of mixing of the fine particles is not considered.

### SUMMARY OF THE INVENTION

In view of the foregoing problems, it is an object of the present invention to provide a heat transport medium with fine-particle dispersion, which can surely improve the heat transport capability by mixing an appropriate volume content of fine particles into a liquid medium.

According to an aspect of the present invention, a heat transport medium for transporting heat transferred from a heat transfer surface, includes a liquid medium, and fine particles of a predetermined material dispersed into the liquid medium. The fine particles are contained in the liquid medium in volume content to provide an improvement rate of a heat transfer coefficient of about 1.0 or more. Here, the heat transfer coefficient is an index representing ease of heat transfer of the medium between the heat transfer surface and the medium by addition of the fine particles.

Generally, the heat transfer coefficient, and a thermal conductivity which is an index representing the ease of transmission of heat within the medium have the following relationship when α is the heat transfer coefficient and λ is the thermal conductivity,
α∝λ^{2/3}/μ^{1/6} (1)
in which μ indicates a viscosity of the above-mentioned medium.

On the other hand, as the fine particles are added to the liquid medium, the viscosity μ of the medium is simply increased according to the added amount. When the fine particles are, for example, nanosized ones, the thermal conductivity λ of the medium can possibly increase drastically at the relatively small volume content, although depending on conditions including the material and particle diameter of the particle. The inventors have found that the improvement rate of the thermal conductivity, that is, the ratio λ/λ₀ of the thermal conductivity λ of the medium after addition of the fine particles to the thermal conductivity λ₀ of the medium before addition of the particles temporarily increases with the increase in the thermal conductivity λ, but tends to converge to an approximately constant value thereafter. In other words, once the improvement rate λ/λ₀ of the thermal conductivity converses (is saturated), the increase in the added amount of the fine particles leads to an increase in viscosity μ of the medium, but does not increase the improvement rate of the thermal conductivity of the medium.

As can be seen from the above-mentioned formula (1), since the heat transfer coefficient α of the heat transport medium is proportional to the ⅔ power of the above thermal conductivity λ, the improvement rate of the heat transfer coefficient, that is, the ratio α/α₀ of the heat transfer coefficient α of the medium after addition of the fine particles to the heat transfer coefficient α₀ of the medium before addition of the fine particles becomes 1.0 or more at least once along with the addition of the particles. However, once a volume content (concentration) is reached, the improvement rate α/α₀ of the heat transfer coefficient becomes below 1.0. That is, the above-mentioned fine particles are contained in a range of volume contents that provides the heat transfer coefficient improvement rate α/α₀ of 1.0 or more for the medium, thereby surely improving the heat transfer coefficient of the heat transport medium. Furthermore, according to the above-mentioned formula (1), there is a high possibility that this range of volume contents of the fine particles to the medium is positioned such that the thermal conductivity improvement rate λ/λ₀ increases or converges (is saturated).

With the above-mentioned constitution (mixed composition) serving as the heat transport medium with fine-particle dispersion, there is an extremely high possibility that both thermal conductivity and heat transfer coefficient of the medium are improved by addition of the bare minimum amount of fine particles into the medium, thus surely improving the heat transport capability at lower manufacturing costs. In calculation of the above-mentioned heat transfer coefficient α, the thermal conductivity λ and the viscosity μ of the medium are determined by measurement or the like using the volume content (concentration) of the particles to the medium as a function of a variable, and then substituted into the above formula (1). Then, the improvement rate α/α₀ of the heat transfer coefficient can be determined as follows:
α/α₀=(λ/λ₀)^{2/3}/(μ/μ₀)^{1/6} (2)
in which μ/μ₀ is the improvement rate of the viscosity μ of the medium, and μ₀ is the viscosity of the medium before addition of the fine particles.

For example, in the heat transport medium of the present invention, the fine particle may have a diameter of 10 nm or less. Furthermore, the liquid medium may be made of a solvent mainly including water which contains one or more kinds of freezing-point depressants. In addition, the liquid medium may contain at least one of ethylene glycol and propylene glycol, or the liquid medium may contain an organic salt. Here, the organic salt may be made of any one of sodium formate, sodium acetate, and potassium acetate.

Alternatively, the liquid medium may be made of an organic solvent or oil, and the fine particle may be made of any material that has a higher thermal conductivity than that of the liquid medium. For example, the fine particle is made of any one of gold, silver, copper, iron, aluminum, alumina, copper oxide, iron oxide, carbon, silicon, and silicon carbide. Furthermore, the fine particle may be covered with a detergent, and the volume content of the fine particles may be set within a range from 0.02% to 0.09%.

### BRIEF DESCRIPTION OF THE DRAWINGS

Additional objects and advantages of the present invention will be more readily apparent from the following detailed description of preferred embodiments when taken together with the accompanying drawings. In which:

FIG. 1 is a graph showing the relationship between a volume content (%) of fine particles and an improvement rate (λ/λ₀) of a thermal conductivity of a medium, according to preferred embodiments of the present invention;

FIG. 2 is a graph showing the relationship between the volume content (%) of the fine particles and a viscosity of the medium in the embodiments;

FIG. 3 is a graph showing the relationship between the volume content (%) of the fine particles and an improvement rate (α/α₀) of a heat transfer coefficient of the medium in the embodiments; and

FIG. 4 is a graph showing the relationship between a volume content (%) of fine particles and a thermal conductivity (K/Ko) of a medium in a heat transport medium with fine-particle dispersion in a related art.

### DETAILED DESCRIPTION OF THE PREFERRED EMBODIMENTS

### First Embodiment

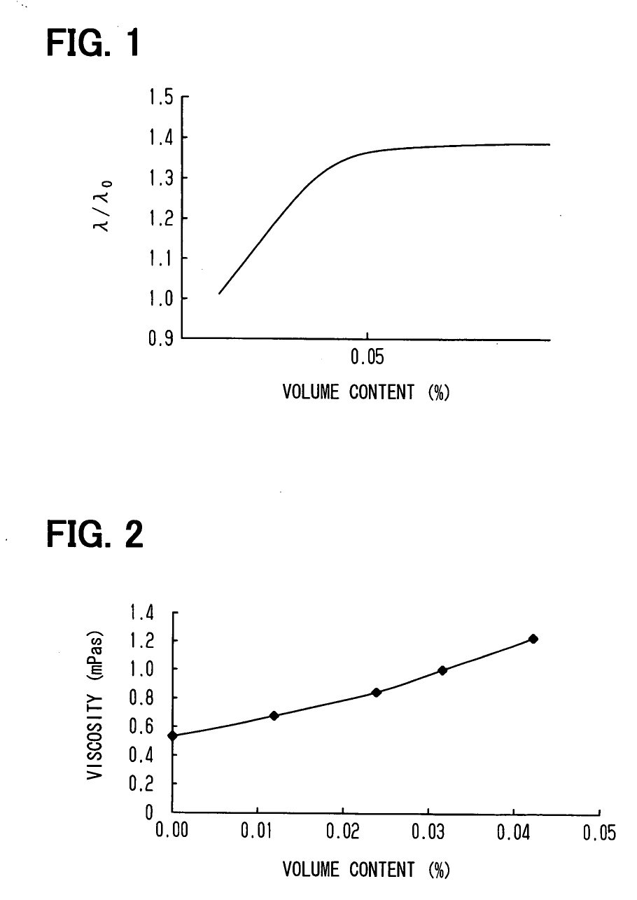

A fine-particle heat transport medium according to a first embodiment of the present invention will be described below with reference to FIGS. 1 to 3.

The fine-particle heat transport medium according to the first embodiment is a medium for transmitting and transporting heat from a heat source to the outside, for example. The medium used in the heat transport medium is made of an organic solvent, such as toluene, which contains fine particles, such as gold (Au), having a higher thermal conductivity than that of the solvent. More specifically, the fine particle of gold is composed of an aggregate of gold atoms, and has a diameter of about 1.5 nm. The use of the fine particles, which has a diameter of 2 nm or less, up to 10 nm experientially, drastically increase the surface area of the fine particles dispersed into the medium. On the other hand, a detergent for protecting each fine particle and enhancing dispersibility thereof is added to the medium. The detergent is one having a thiol group (—SH) which tends to be attached to metal particles, such as gold, and having a high affinity for a non-polar organic solvent, such as toluene. For example, thiol (HS—(CH₂)₁₇—CH₃) in which eighteen carbon atoms are connected in a linear chain can be used as the detergent.

The thermal conductivity of the fine-particle heat transport medium of the embodiment was measured using the volume content of the fine particles as a parameter. FIG. 1 shows a change in the ratio λ/λ₀ of a thermal conductivity λ of the medium after addition of the fine particles to a thermal conductivity λ₀ of the medium before addition of the fine particles, that is, a change in the improvement rate λ/λ₀ of the thermal conductivity, with respect to the volume content of the fine particles added to the medium. As shown in FIG. 1, in a range where the volume content is small, specifically, in a range of volume contents of not more than about 0.05%, the improvement rate λ/λ₀ of the thermal conductivity is improved greatly with the increase in volume content. However, in a range where the volume content is higher than 0.05%, the improvement rate λ/λ₀ of the thermal conductivity is improved gradually and thereafter tends to converge to a substantially constant value. That is, once the improvement rate λ/λ₀ of the thermal conductivity converses (is saturated), even the increase in the added amount of the fine particles hardly increase the improvement rate of the thermal conductivity of the medium.

On the other hand, FIG. 2 shows the relationship between the volume content of the fine particles added to the medium and a viscosity of the medium. As shown in FIG. 2, the viscosity μ of the medium increases with the increase in volume content of the fine particles, or with the increase in the amount of addition of the fine particles.

It is generally known that the above-mentioned thermal conductivity is the index representing the ease of transmission of heat within the medium, while the heat transfer coefficient is an index representing the ease of transfer of heat between the medium and a transfer surface for transferring the heat to the medium, by addition of the fine particles. When α is the heat transfer coefficient of the medium, the thermal conductivity λ and the viscosity μ have the following relationship:
α∝λ^{2/3}/μ^{1/6} (1)
In the addition of the fine particles to the medium, when α₀ is the heat transfer coefficient before the addition of the fine particles, μ₀ is the viscosity of the medium, and α/α₀ is the improvement rate of the heat transfer coefficient α, the improvement rate λ/λ₀ of the thermal conductivity λ and the improvement rate μ/μ₀ of the viscosity μ have the following relationship:
α/α₀=(λ/λ₀)^{2/3}/(μ/μ₀)^{1/6} (2)

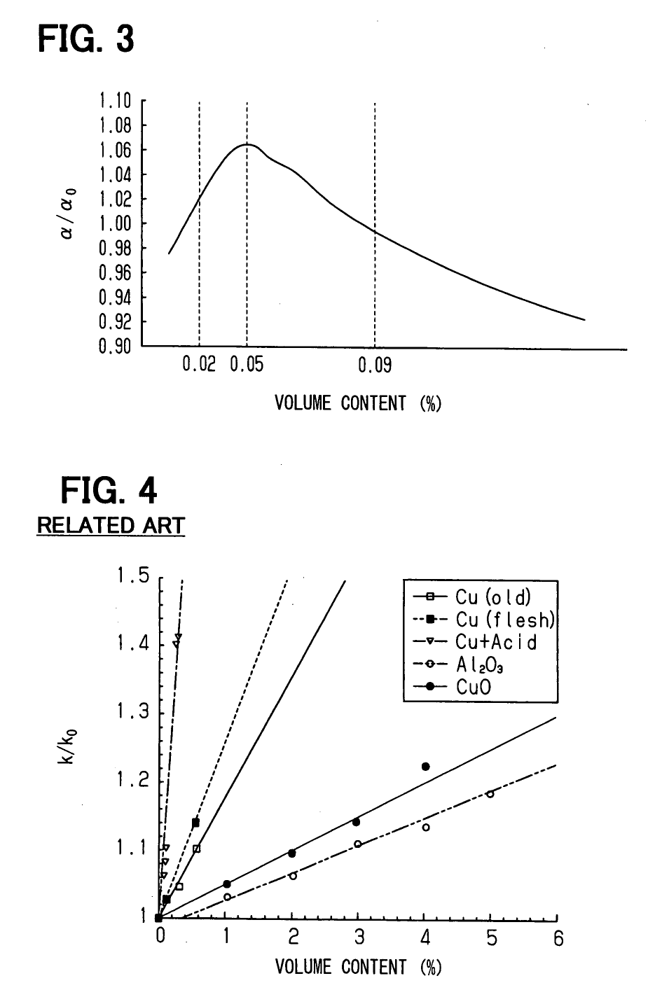

In the heat transport medium with fine-particle dispersion according to the embodiment, the improvement rate λ/λ₀ of the thermal conductivity and the viscosity μ of the medium, and the viscosity μ₀ of the medium before addition of the fine particles, which are measured as mentioned above, are substituted into the above-mentioned formula (2) to determine the improvement rate α/α₀ of the heat transfer coefficient. FIG. 3 shows the relationship between the volume content of the fine particles and the improvement rate α/α₀ of the heat transfer coefficient calculated as mentioned above.

When x is the volume content of the fine particles and y is the improvement rate α/α₀ of the heat transfer coefficient, these elements can be approximated by the following formula:
y=5×10¹⁷x⁶−7+5×10¹²x⁶−5×10⁹x³+1×10⁶x²+325.67x+0.9291 (3)

As calculated from this formula (3), and as shown in FIG. 3, the improvement rate α/α₀ of the heat transfer coefficient reaches the maximum value when the volume content of the fine particles is about 0.05%. In a range of volume contents from about 0.02% to 0.09%, the improvement rate α/α₀ of the heat transfer coefficient becomes approximately equal to or above 1.0. That is, when the addition amount of the fine particles to the medium is set in a range of volume contents that provides the improvement rate of the heat transfer coefficient of about 1.0 or more, that is, when the volume content of the particles is set within a range from 0.02% to 0.09%, the heat transfer coefficient of the medium can be effectively improved. With this arrangement (composition) of the heat transport medium with fine-particle dispersion, the addition of the bare minimum amount of the fine particles to the medium can improve both the thermal conductivity and heat transfer coefficient, thus surely improving the heat transport capability.

As mentioned above, according to the heat transport medium with fine-particle dispersion of this embodiment can provide the following listed effects.

(1) In the fin-particle heat transport medium including the fine particles of gold in the solvent of toluene for transporting heat transmitted from the heat transfer surface, the above-mentioned particles are contained in the solvent in the volume content that provides the improvement rate α/α₀ of the heat transfer coefficient of the medium of about 1.0 or more by the addition of the fine particles. This improves both the thermal conductivity and the heat transfer coefficient of the medium by addition of the bare minimum amount of the fine particles into the medium, thus surely improving the heat transport capability at lower manufacturing costs.

(2) The fine particle has a diameter of about 1.5 nm. Thus, there clearly appears a phenomenon in which the thermal conductivity λ of the medium drastically increases (is improved) with respect to the volume content of the fine particles dispersed into the medium.

(3) The material having the higher thermal conductivity than that of the medium is used for the fine particles. This enhances the thermal conductivity and heat transfer coefficient of the heat transport medium, which permits the heat transport capability to remain high.

(4) The fine particles are covered with the detergent. This can further enhance the dispersibility of the fine particles into the medium, so that the heat transport capability of the heat transport medium with fine-particle dispersion can be improved.

### Second Embodiment

Next, a heat transport medium with fine-particle dispersion according to a second embodiment of the present invention will be described below.

The heat transport medium with fine-particle dispersion of this embodiment is used as a coolant (LLC: Long Life Coolant), like the previous embodiment. The second embodiment differs from the first embodiment in that the medium mainly consists of water containing a liquid freezing-point depressant, such as ethylene glycol, propylene glycol, or the like. Thus, the medium of this embodiment becomes a so-called anti-freeze solution which does not freeze up in the normal use. On the other hand, iron oxide particles or the like having a diameter of, for example, 10 nm or less are used as the fine particles to be dispersed into the medium. In order to enhance the dispersibility of the fine particles into the medium, the detergent is added to the medium. The detergent is one having the thiol group which tends to be attached to metal particles, and having a hydroxyl group which has a high affinity for a polar solvent, such as water, ethylene glycol, propylene glycol, or the like. For example, mercaptosuccinic acid (HOOC—CH₂—(SH)—CH₂—COOH) or the like can be used as the detergent.

In this embodiment, the improvement rate of the thermal conductivity of the medium and the improvement rate of the viscosity thereof are measured using the volume content of the fine particles to the medium as a parameter, and thus the improvement rate of the heat transfer coefficient is calculated using the above-mentioned formula (2). The amount of addition of the fine particles into the medium is set to a range of volume contents that provides the improvement rate of the heat transfer coefficient of about 1.0 or more. This can improve both thermal conductivity and heat transfer coefficient of the medium by addition of the bare minimum amount of the fine particles into the medium.

As mentioned above, the heat transport medium with fine-particle dispersion according to the second embodiment can also provide the same effects as the above-mentioned effects (1) to (5) of the above-described first embodiment and the similar effects thereto, as well as the following effects.

(5) The LLC used as the above-mentioned medium is useful especially for application as coolants for a vehicle-mounted engine, for example.

(6) The above-mentioned medium contains the freezing-point depressant. Thus, the heat transport medium may be the anti-freeze solution, thereby greatly enhancing the utility of the medium at low temperature.

### Other Embodiments

It should be noted that the heat transport medium with fine-particle dispersion according to the invention is not limited to the compositions as described in the first and second embodiments, and the following embodiments which are obtained by appropriately modifying the above embodiments can also be implemented.

In the above-described first embodiment, toluene is used as the medium, but the invention is not limited thereto. As the medium, can be used an organic solvent composed of a single solvent, such as hexane, benzene, diethyl ether, chloroform, acetic ether, tetrahydrofuran, methylene chloride, acetone, acetonitrile, N,N-dimethylformamide, dimethyl sulfoxide, butanol acetate, 2-propanol, 1-propanol, ethanol, methanol, formic acid or the like, or oil or the like composed of a mixture of a plurality of components, such as engine oil, used for industry or for a vehicle. The described oil among them is useful especially for application as cooling and lubricating oil for various machines, the vehicle-mounted engine, or the like.

In the second embodiment, the liquid freezing-point depressant is added to the medium mainly consisting of water, but the invention is not limited thereto. Instead of this, a solid freezing-point depressant composed of an organic salt, such as sodium formate or potassium acetate, may be added. That is, the freezing-point depressant can have only to be added to convert the above-mentioned medium into the anti-freeze solution.

As the fine particles, gold (Au) can be used in the first embodiment, and iron oxide in the second embodiment, respectively. Instead of them, for example, silver (Ag), copper (Cu), iron (Fe), aluminum (Al), alumina (Al₂O₃), copper oxide (CuO), silicon (Si), silicon carbide (SiC), or the like may be used. That is, the dispersion of these fine particles into the medium can have only to improve the thermal conductivity and heat transfer coefficient of the medium.

Although as the detergent, the thiol is used in the first embodiment, and mercaptosuccinic acid in the second embodiment, respectively, the invention is not limited thereto. A detergent having a functional group that has a high affinity for the medium and the fine particles dispersed into the medium can be used. When the medium is made of a non-polar solvent, such as toluene or hexane, it is preferable that the detergent having an element added thereto which tends to be attached to the metal, such as sulfur, is employed. In contrast, when the medium is made of a polar solvent, such as water or ethylene glycol, the detergent with a polar group, such as hydroxyl group (OH group) is desirably employed. As an example with good dispersibility, in use of the organic solvent, such as toluene or hexane, fatty acid (CₘHₙCOOH), alkylamine, or the like can be used as the detergent. When the dispersibility of the fine particles into the medium can be ensured sufficiently, the use of the detergent can be omitted.

Although in each embodiment, the fine particle used basically has a diameter of 10 nm or less, the invention is not limited thereto. When the thermal conductivity and heat transfer coefficient of the medium can be improved by setting the volume content of the fine particles dispersed into the medium to a range that provides the improvement rate of the heat transfer coefficient of about 1.0 or more, any fine particle having a larger diameter can be employed.

Such changes and modifications are to be understood as being within the scope of the present invention as defined by the appended claims.

What is claimed is:

1. A heat transport medium for transporting heat transferred from a heat transfer surface, comprising:
a liquid medium; and
fine particles of a predetermined material dispersed into the liquid medium,
wherein the fine particles are contained in the liquid medium in a volume content to provide an improvement rate of a heat transfer coefficient of about 1.0 or more, the heat transfer coefficient being an index representing ease of heat transfer of the medium between the heat transfer surface and the medium by addition of the fine particles.

2. The heat transport medium according to claim 1, wherein the fine particle has a diameter of 10 nm or less.

3. The heat transport medium according to claim 1, wherein the liquid medium is made of a solvent mainly including water which contains one or more kinds of freezing-point depressants.

4. The heat transport medium according to claim 3, wherein the liquid medium contains at least one of ethylene glycol and propylene glycol.

5. The heat transport medium according to claim 3, wherein the liquid medium contains an organic salt.

6. The heat transport medium according to claim 5, wherein the organic salt is made of any one of sodium formate, sodium acetate, and potassium acetate.

7. The heat transport medium according to claim 1, wherein the liquid medium is made of an organic solvent.

8. The heat transport medium according to claim 1, wherein the liquid medium is made of oil.

9. The heat transport medium according to claim 1, wherein the fine particle is made of a material that has a higher thermal conductivity than that of the liquid medium.

10. The heat transport medium according to claim 9, wherein the fine particle is made of any one of gold, silver, copper, iron, aluminum, alumina, copper oxide, iron oxide, carbon, silicon, and silicon carbide.

11. The heat transport medium according to claim 1, wherein the fine particle is covered with a detergent.

12. The heat transport medium according to claim 1, wherein, when x is the volume content of the fine particles and y is the improvement rate of the heat transfer coefficient, the volume content and the improvement rate has the following relationship:
y=5×10¹⁷x⁶−7+5×10¹²x⁶−5×10⁹x³+1×10⁶x²+325.67x+0.9291.

13. The heat transport medium according to claim 1, wherein the volume content of the fine particles is set within a range from 0.02% to 0.09%.
